(19) United States
(12) Patent Application Publication
(10) Pub. No.: US 2025/0278686 A1
(43) Pub. Date: Sep. 4, 2025

(54) SYSTEM AND METHOD FOR OPTIMIZING RESPONSES TO CYBER ATTACKS

(71) Applicant: CyberActive Technologies LLC, Wilmington, DE (US)

(72) Inventor: David Makovoz, Silver Spring, MD (US)

(21) Appl. No.: 19/056,199

(22) Filed: Feb. 18, 2025

Related U.S. Application Data
(60) Provisional application No. 63/559,648, filed on Feb. 29, 2024.

(51) Int. Cl. G06Q 10/0635; H04L 9/40; H04L 41/16

(52) U.S. Cl. CPC G06Q 10/0635; H04L 41/16; H04L 63/1441

(57) ABSTRACT

A system includes a computer. The computer includes a processor and a memory. The memory includes instructions such that the processor is programmed to: determine a loss caused by at least one cyber-attack; determine a loss caused by business disruptions resulting from responses to the at least one cyber-attack; and select an optimal response to the at least one cyber-attack to minimize the losses.

### BACKGROUND

Computer networks may include multiple computing assets that enable users to access shared resources including a variety of digital content accessible by a communication network. A computer network can be a set of computers connected to form one or more nodes within a personal area network, a local/virtual area network, a wide area network, or any other type of network architecture associated with a collection of computing devices.

Access to the Internet external to a particular network presents a variety of cyber security challenges. As such, computing assets within an example computer network may be susceptible to data breaches or attacks from malicious users seeking unauthorized access to one or more assets within the network. Organizations commonly employ incident response playbooks that outline specific procedures for responding to and recovering from various types of cybersecurity incidents.

While these playbooks aim to reduce attack dwell time and mitigate impact through containment and eradication measures, the responses themselves can cause significant business disruptions. For example, disconnecting critical systems can halt dependent business processes, changes to firewall rules might block legitimate traffic, and disabling compromised accounts can prevent users from performing essential functions. Traditional playbooks do not account for or optimize the balance between attack mitigation and business continuity.

### SUMMARY

A system includes a computer. The computer includes a processor and a memory. The memory includes instructions such that the processor is programmed to: determine a loss caused by at least one cyber-attack; determine a loss caused by business disruptions resulting from responses to the at least one cyber-attack; and select an optimal response to the at least one cyber-attack to minimize the losses.

In other features, the processor is further programmed to utilize Monte Carlo simulations to quantify potential losses from both the cyber-attack and business disruptions.

In other features, the processor is further programmed to generate probability distributions representing frequency and severity of potential cyber-attacks.

In other features, the processor is further programmed to generate probability distributions representing business disruption costs for different response measures.

In other features, the processor is further programmed to calculate attack success reduction factors for different response measures.

In other features, the processor is further programmed to create a data structure that maps optimal responses to different types of cyber-attacks based on minimizing total combined losses.

In other features, the processor is further programmed to select at least one of a random forest with dynamic weighting, a Deep Q-Network, a Siamese neural network, or a one-shot learning with prototypical network to match zero-day attacks with known attack profiles to determine appropriate responses.

A method is disclosed that includes determining a loss caused by at least one cyber-attack and determining a loss caused by business disruptions resulting from responses to the at least one cyber-attack. The method also includes selecting a response to the at least one cyber-attack to minimize the losses.

In other features, the method includes utilizing Monte Carlo simulations to quantify potential losses from both the cyber-attack and business disruptions.

In other features, the method includes generating probability distributions representing frequency and severity of potential cyber-attacks.

In other features, the method includes generating probability distributions representing business disruption costs for different response measures.

In other features, the method includes calculating attack success reduction factors for different response measures.

In other features, the method includes creating a data structure that maps optimal responses to different types of cyber-attacks based on minimizing total combined losses.

In other features, the method includes selecting at least one of a random forest with dynamic weighting, a Deep Q-Network, a Siamese neural network, or a one-shot learning with prototypical network to match zero-day attacks with known attack profiles to determine appropriate responses.

A system includes a computer. The computer includes a processor and a memory. The memory includes instructions such that the processor is programmed to: determine a loss caused by at least one cyber-attack; determine a loss caused by business disruptions resulting from responses to the at least one cyber-attack; create a data structure that maps responses to different types of cyber-attacks based on minimizing total combined losses; and select a response from the data structure to the at least one cyber-attack to minimize the losses.

In other features, the processor is further programmed to utilize Monte Carlo simulations to quantify potential losses from both the cyber-attack and business disruptions.

In other features, the processor is further programmed to generate probability distributions representing frequency and severity of potential cyber-attacks.

In other features, the processor is further programmed to generate probability distributions representing business disruption costs for different response measures.

In other features, the processor is further programmed to calculate attack success reduction factors for different response measures.

In other features, the processor is further programmed to select at least one of a random forest with dynamic weighting, a Deep Q-Network, a Siamese neural network, or a one-shot learning with prototypical network to match zero-day attacks with known attack profiles to determine appropriate responses.

### BRIEF DESCRIPTION OF THE DRAWINGS

FIG. 1 is a diagram of an example computing environment.

FIG. 2 is a diagram of an example computing device.

FIG. 3 is a diagram illustrating example set of cyber-attacks, a group of assets, and responses to the set cyber-attacks.

FIG. 4 is a diagram illustrating a probability density of loss values.

FIG. 5 is a diagram illustrating a probability distribution of a number of incidents per unit time.

FIG. 6 is a diagram illustrating potential responses including containment and eradication.

FIG. 7 is a diagram illustrating a loss exceedance curve based on a Monte Carlo simulation.

FIG. 8 is a diagram illustrating a data structure that includes optimal responses for each possible attack for each possible group of assets.

FIG. 9 is a flow diagram illustrating a process for determining optimal responses.

### DETAILED DESCRIPTION

The present disclosure describes a system and a method to select responses to cyber-attacks, where the response to an attack is selected in the business context of the digital infrastructure of the organization experiencing the cyber-attack. As described herein, the present disclosure applies the principles of cyber risk quantification (CRQ) to quantify the damages caused by the attack as well as the damages created by the business disruption and formulates the response strategy that minimizes the total damage caused by both the attack and the business disruption.

In an example implementation, the present disclosure can use Monte Carlo simulations, a CRQ tool, to produce quantitative assessments of the damages. The present disclosure uses Monte Carlo simulations to estimate losses due to business disruptions caused by responses to cyber-attack with the ultimate goal of finding a response that minimizes the overall losses. The output is used to generate responses in near-real time that can be used to mitigate cyber-attacks. In various implementations, it is understood that the Monte Carlo simulations can be executed offline.

However, in some instances, the cyber-attack is a new attack, i.e., zero-day, that has not been observed and/or planned for. The present disclosure further describes a system and a method to select a response for the new attack and/or for some other circumstances where there is predefined response.

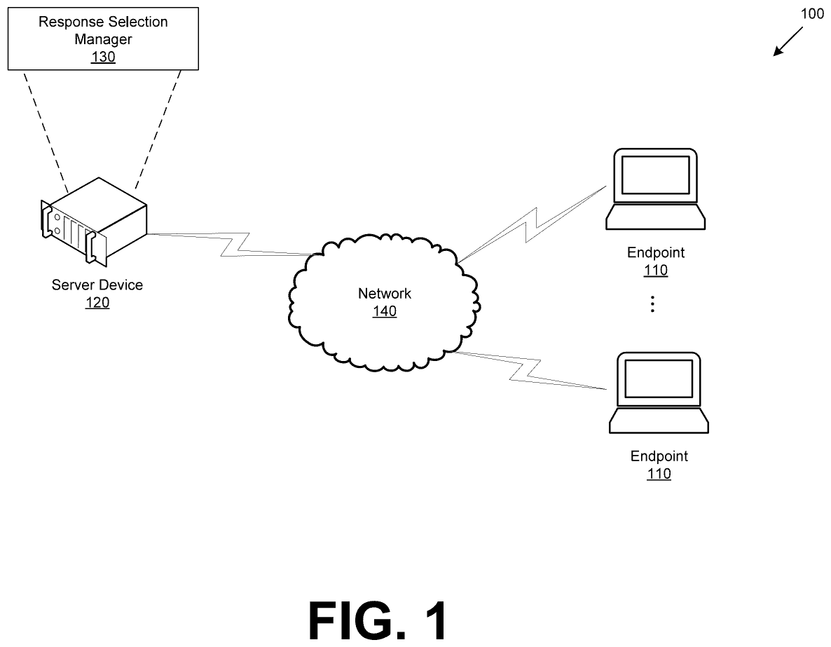

FIG. 1 illustrates an example environment 100 that includes a set of user devices 110 (referred to collectively as “endpoints 110” and individually as “endpoint 110”), a set of server devices 120 (referred to collectively as “server devices 120” and individually as “server device 120”), a response selection manager 130, and a network 140. Devices of environment 100 may interconnect via wired connections, wireless connections, or a combination of wired and wireless connections.

The endpoint 110 includes one or more devices capable of receiving, generating, storing, processing, and/or providing information associated with cyber security events and responses. For example, the endpoint 110 may include a desktop computer, a mobile phone, a laptop computer, a tablet computer, a handheld computer, a gaming device, a wearable communication device, e.g., a smart wristwatch, a pair of smart eyeglasses, etc., or a similar type of device.

The server device 120 includes one or more devices capable of receiving, providing, storing, processing, and/or generating information associated with cyber security events and responses. For example, the server device 120 may include a server (e.g., in a data center or a cloud computing environment), a data center (e.g., a multi-server micro data center), a workstation computer, a virtual machine (VM) provided in a cloud computing environment, or a similar type of device. In some implementations, the server device 120 may include a communication interface that allows the server device 120 to receive information from and/or transmit information to other devices in environment 100.

The response selection manager 130 includes a computing system of one or more devices capable of processing information from and/or transmitting information to the endpoints 110, as described in greater detail below. In an example implementation, as shown in FIG. 1, the server device 120 includes the response selection manager 130. In some examples, the server device 120 may comprise a cloud server or a group of cloud servers. In some implementations, the response selection manager 130 may be designed to be modular, such that certain software components can be swapped in or out depending on a particular need.

The network 140 includes one or more wired and/or wireless networks. For example, the network 140 may include a cellular network (e.g., a long-term evolution (LTE) network, a code division multiple access (CDMA) network, a 3G network, a 4G network, a 5G network, another type of cellular network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

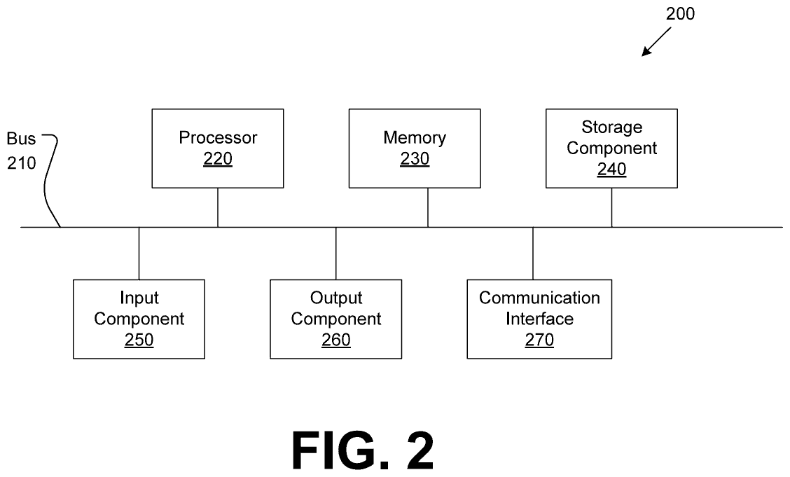

FIG. 2 is a diagram of example components of a device 200. The device 200 may correspond to the endpoint 110, the server device 120. In some implementations, the endpoint 110 and/or the server device 120, may include one or more devices 200 and/or one or more components of the device 200. As shown in FIG. 2, the device 200 may include a bus 210, a processor 220, a memory 230, a storage component 240, an input component 250, an output component 260, and a communication interface 270.

The bus 210 includes a component that permits communication among the components of device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random-access memory (RAM), a read-only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like

The device 200 may perform one or more processes described herein. The device 200 may perform these processes based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

The response selection manager 130 implements techniques for balancing attack mitigation with business continuity. For example, the response selection manager 130 can apply cyber risk quantification principles to determine optimal responses that minimize total damages from both the attack and resulting business disruptions. Monte Carlo simulations can be used to model the probability of different outcomes in processes that are difficult to predict due to the intervention of random variables. In the context of evaluating damages from business disruptions due to cybersecurity responses, Monte Carlo simulations can estimate the financial impact by taking into account the variability and uncertainty of multiple risk factors.

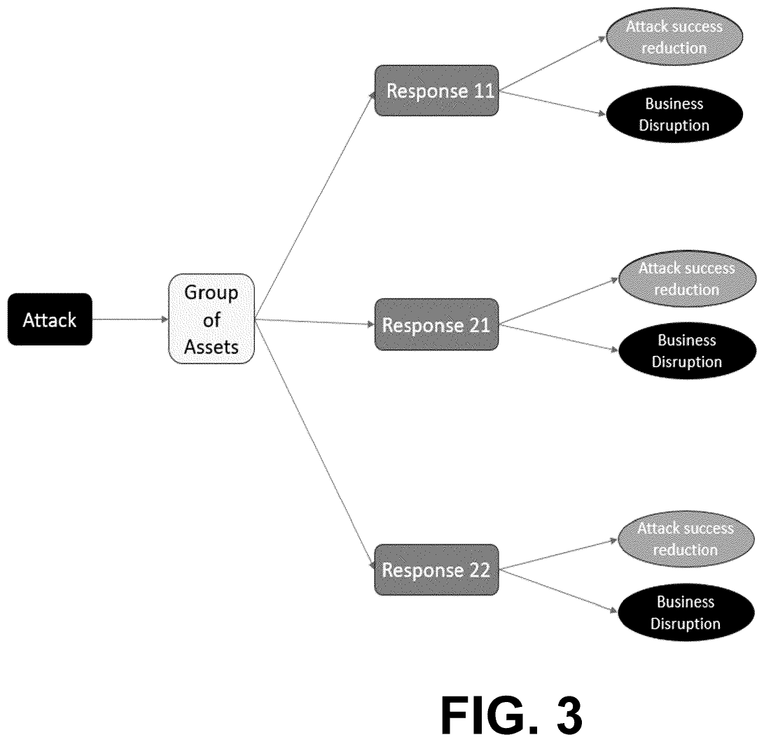

The response selection manager 130 maintains an inventory of organizational assets and users, along with a data structure, i.e., a playbook, that stores containment and eradication steps for potential attacks. Each attack can affect certain groups of assets and maps to multiple possible responses. In an example implementation, the above can be represented by a set of Attacks {A}, Groups of Assets {GA}, Responses to Attacks on a Group of Assets {R (A, GA)} (see FIG. 3). In what follows the dependence of R on A and GA will be assumed, and simple notation R will be used instead of R (A, GA). In order to categorize attacks, tactics and techniques from the MITRE AT&CK framework can be used as a possible option.

A non-inclusive list of common static attributes that can be used for categorizing assets:
Device type, such as servers, desktops, laptops, firewalls, routers, switches, wireless access points, printers, and IoT devices.
Operating systems, such as Windows, macOS, Linux, IOS, Android, or proprietary systems for specialized hardware.
Security status, such as patch level, presence of security software, and adherence to security policies.
Criticality, i.e., rank devices by their importance to business operations.
Connection to the network, such as wired, wireless, VPN, or direct internet connection.

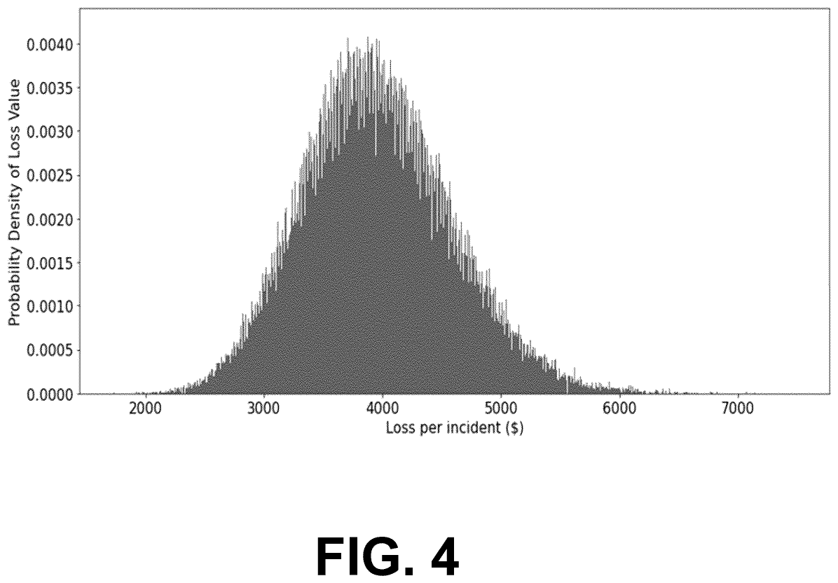

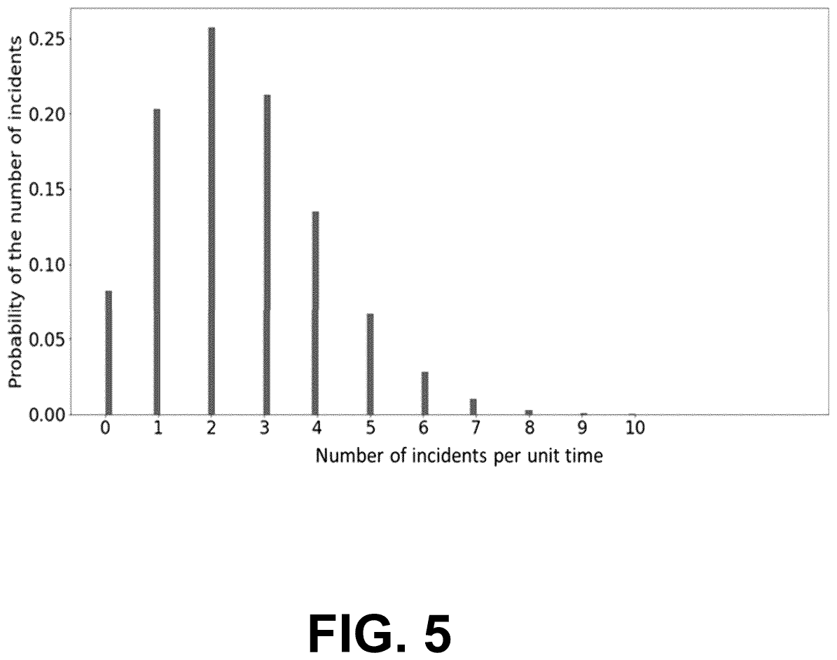

Each attack is characterized by two probability distributions: a probability distribution [symbol] (N_{A}|A) of the number of incidents N_{A} per unit time. In what follows we assume the unit time to be 1 day, but in general it can be anywhere from several hours to several days or even weeks. Each pair (A, GA) is characterised by a probability distribution [symbol] (L|A, GA) of potential losses L per incident. FIG. 4 illustrates a probability distribution of the number of incidents per unit time. FIG. 5 illustrates a probability distribution of potential losses per incident. Each pair (R, GA) is characterized by probability distribution [symbol] (I|R, GA) of the losses l due to business disruptions.

The response selection manager 130 utilizes Monte Carlo simulations to model potential outcomes and losses. In an example implementation, the response selection manager 130 accounts for variables that contribute to losses incurred by cyber-attacks. These variables define the model parameters of the probability distribution [symbol] (L|A, GA) of the potential losses and the number of incidents probability distribution [symbol] (N_{A}|A). The variables can include, but are not limited to:

### Data Exfiltration Attack

Data Sensitivity: The classification level (e.g., public, confidential, secret, top secret) and type of data (e.g., PII, PHI, trade secrets).
Data Volume: The amount of data that can potentially be exfiltrated.

### Ransomware Attack:

Backup Integrity: The frequency, recency, and reliability of data backups.
Patch Management: The timeliness and consistency of applying security patches to prevent exploitation.
Endpoint Protection: The effectiveness of endpoint security solutions in detecting and preventing malware.

### Distributed Denial of Service (DDOS) Attack

Bandwidth Capacity: The maximum bandwidth available that could be saturated during an attack.
DDOS Mitigation Services: The presence and effectiveness of DDOS protection services.
Redundancy: The existence of redundant network paths or services that can take over in case of an attack.

### Phishing Attack

Email Filtering: The effectiveness of email security systems in filtering out phishing emails.
Multi-Factor Authentication (MFA): The usage and effectiveness of MFA in mitigating the impact of compromised credentials.
User Awareness: The probability of users clicking on malicious links or attachments, based on the level of security training.

### Insider Threat

User Privileges: The extent of access privileges granted to employees, particularly those with access to sensitive data.
Data Loss Prevention (DLP): The presence and effectiveness of DLP measures to prevent unauthorized data transfers.

### SQL Injection Attack

Input Validation: The robustness of input validation measures to prevent SQL injection.
Database Encryption: The use of encryption for sensitive data in databases.
Web Application Firewalls (WAFs): The deployment and tuning of WAFs to detect and block SQL injection attempts.

### Zero-Day Exploit

Network Segmentation: The degree to which the network is compartmentalized to limit lateral movement.
Micro-segmentation: The use of fine-grained security policies to isolate systems and minimize the attack surface.
Access Controls: The strength and effectiveness of access control mechanisms in place.

To estimate the losses due to business disruptions caused by cybersecurity response measures using a Monte Carlo simulation, response selection manager 130 considers a range of factors that can influence the extent and cost of the disruptions. These factors can determine the probability distributions [symbol] (l|R (A, GA), GA) of the losses. Some key factors include, but are not limited to:
1. Systems critical to business operations and the potential impact if they are taken offline.
2. The duration of downtime for each critical system affected by the response measures. This can include time for containment, eradication, and recovery.
3. Direct and indirect impacts of disruptions on specific business.
4. The potential loss in revenue for each unit of time that a system or process is unavailable.
5. The costs associated with implementing temporary workarounds to maintain business operations during the disruption.
6. The loss in employee productivity due to system unavailability or changes in access.
7. Penalties or reputational damage associated with failing to meet SLAs due to service disruptions.
8. The potential impact on customers, including loss of service and potential churn.
9. Regulatory or compliance implications that may arise due to disruptions.

As new data becomes available (e.g., actual costs from past incidents), the model parameters and distributions can be modified to improve the accuracy of the simulation. The probability estimates can be obtained from historical data, from publicly available cyber-attack data, and from interviewing subject matter experts.

In the context of Monte Carlo simulations for CRQ, the choice of probability distributions can be important for accurately modelling different aspects of cyber risk. These distributions are used to model various components of cyber risk, such as the frequency of incidents, the severity of losses, the effectiveness of incident responses, and/or security controls. The chosen distributions are often based on historical data, industry benchmarks, expert judgments, and the specific risk profile of the organization. Some common distributions used in CRQ are:

TABLE 1

| Distribution Name | Usage |
|---|---|
| Lognormal | Model the distribution of the cost of individual |
| Distribution | cyber incidents, especially when costs are |
| | positively skewed and vary over a wide range. |
| Poisson or Negative | Model the frequency of cyber incidents, |
| Binomial Distribution | especially when incidents are rare, or the data |
| | is overly dispersed (variance greater than the |
| | mean). |
| Beta Distribution | Model probabilities and rates that are bounded |
| | between 0 and 1, such as the probability of a |
| | successful cyber-attack given an attempt |
| Gamma Distribution | Model the waiting times between cyber events or |
| | the time required to detect and respond to |
| | incidents |
| Uniform Distribution | Applied in scenarios where there is little to no |
| | information about the likelihood of different |
| | outcomes, providing a baseline model where all |
| | outcomes are equally likely |
| Exponential | Model the time between cyber incidents in a |
| Distribution | continuous process, assuming a constant rate |
| | of occurrence |

It is possible to construct various probability distributions using a limited set of parameters such as the mean, maximum, and minimum values:

TABLE 2

| Distribution Name | Parameters |
|---|---|
| Lognormal | Mean and standard deviation of the underlying |
| Distribution | normal distribution |
| Poisson or Negative | Rate (λ), which is also the mean |
| Binomial Distribution | |
| Beta Distribution | Two shape parameters (α and β) |
| Gamma Distribution | Shape (k) and Scale (θ) or Rate (β = 1/θ) |
| Uniform Distribution | Minimum and Maximum |
| Exponential | Rate (λ) or Mean (μ = 1/λ) |
| Distribution | |

For a traditional CRQ problem the following formula is used to compute the loss for a run of simulations run for a D days

$$Loss ( A , GA ) = {\sum }_{d = 1}^{D} ( {\sum }_{j = 1}^{{n}_{d}} {L}_{dj} ) \qquad Eq . 1$$

Here the number of incidents n_{d} is a sample drawn from the [symbol] (N_{A}|A) for day d, loss L_{dj} is a sample drawn from the loss distribution [symbol] (L|A, GA) for the j^{th} incident on day d.

It is understood that a response reduces the probability of the attack to continue can be represented by the Attack Success Reduction factor ASR(A, R), which is a number in range [0,1]. Including a specific Response R to the Attack A on a Group of Assets GA yields the following formula for the loss for one run of simulations run for a D days:

$$Loss ( A , GA , R ) = {\sum }_{d = 1}^{D} ( {\sum }_{j = 1}^{{n}_{d}} ( {P}_{dj} \cdot {L}_{dj} + {l}_{dj} ) ) \qquad Eq . 2$$

Here l_{dj} is a sample drawn from the loss distribution [symbol] (I|R, GA); P_{dj} is a random variable drawn from the Bernoulli distribution:

$$Probability ( {P}_{dj} = 0 ) = ASR ( A , R ) \qquad Eq . 3$$

$$Probability ( {P}_{dj} = 1 ) = ( 1 - ASR ( A , R ) ) \qquad Eq . 4$$

Inclusion of Response R modifies the equation by reducing the number of incidents proportionally to (1−ASR(A, R)), thus reducing the total losses due to the cyber-attack.

In an example implementation, the response selection manager 130 can compute the loss repeatedly from tens of thousands times to tens of millions times. For each run, the total loss is calculated and all total losses are collected. This calculation can be performed separately for each combination of (A, GA, R).

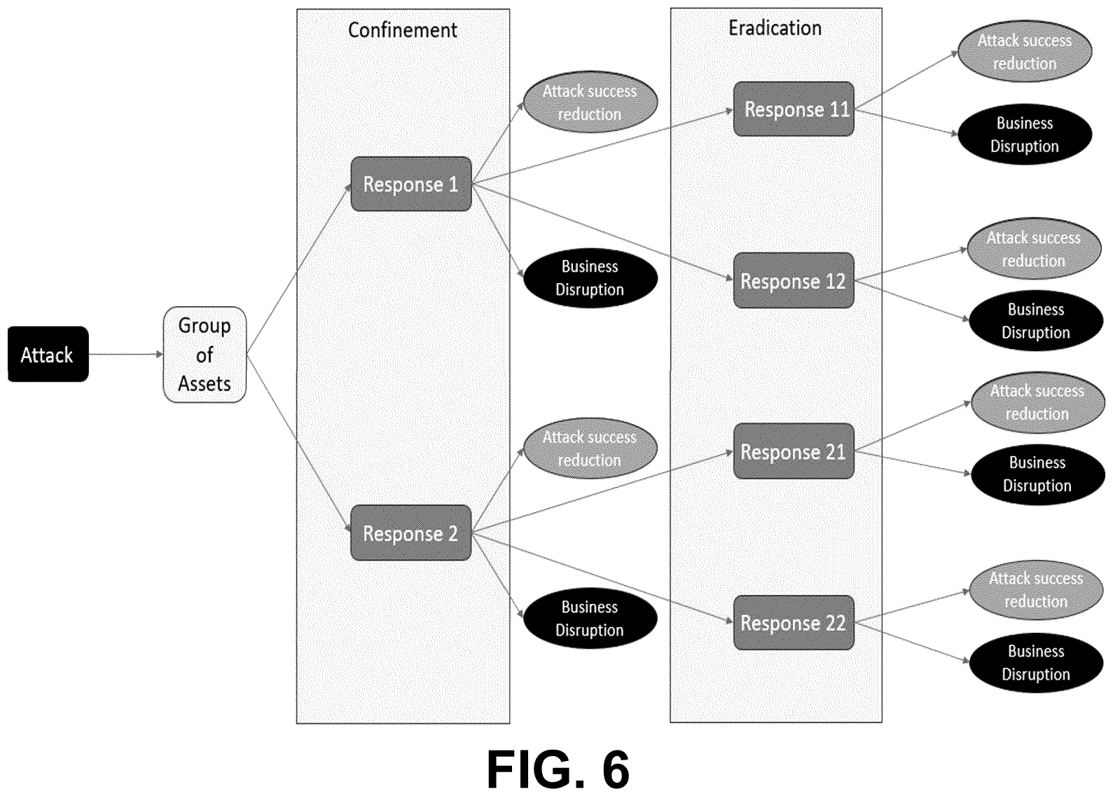

There could be two levels of responses: containment and eradication. In this case each level with have its own Attack Success Reduction factor—ASR^{C} for containment responses and ASR^{E} for eradication responses and business losses (see FIG. 6). Equation 2 can be modified as follows:

$$Loss ( A , GA , {R}^{C} , {R}^{E} ) = {\sum }_{d = 1}^{D} ( {\sum }_{j = 1}^{{n}_{d}} ( {P}_{dj}^{C} \cdot γ \cdot {L}_{dj} + {P}_{dj}^{C} \cdot {P}_{dj}^{E} \cdot ( 1 - γ ) {L}_{dj} + {l}_{dj}^{C} + ( 1 - {P}_{dj}^{C} ) \cdot {l}_{dj}^{E} ) ) \qquad Eq . 5$$

The attack-inflicted losses are accumulated. Since the probability distribution [symbol] (L|A, GA) represents the total losses from an attack, the losses at two stages are split into two parts γ·L_{dj} and (1−γ)·L_{dj} which add up to L_{dj}.

Considering a cyber-attack, if containment succeeds (P_{dj}^{C}=0), then there is no attack-inflicted losses; if containment fails, but eradication succeeds (P_{dj}^{C}=1, P_{dj}^{E}=0), then the loss-inflicted losses are γ·L_{dj} if both containment and eradication fails (P_{dj}^{C}=1, P_{dj}^{E}=1), then the attack-inflicted losses are L_{dj}. The term (1−P_{dj}^{C})·l_{dj}^{E} indicates that eradication response losses will only be incurred if the containment response doesn't stop the progress of the attack.

Generally, it may take several consecutive responses to stop an attack. The longer an attack persists, the greater the attack-inflicted and business interruption losses grow. Equation 5 is generalized to the case of rmax responses as follows:

$$Loss ( A , GA , \{ {R}^{i} \} ) = {\sum }_{d = 1}^{D} ( {\sum }_{j = 1}^{{n}_{d}} {ℒ}_{dj} ) \qquad Eq . 6$$

$${ℒ}_{dj} = {L}_{dj} \cdot {\sum }_{r = 1}^{rmax} {P}_{dj}^{r} \cdot {γ}_{r} + {\sum }_{r = 1}^{rmax} ( {l}_{dj}^{r} \cdot {\prod }_{i = 1}^{r - 1} ( 1 - {P}_{dj}^{i} ) ) \qquad Eq . 7$$

Here the convention Πᵢ₌₁⁰ (1−P_{dj}ⁱ)=1 is assumed.

Each response R^{r} is characterized by its loss distribution [symbol] (l|R^{r}, GA) and Attack Success Reduction factor ASR^{r}(A, R^{r}). P_{dj}^{r} are randoms variable drawn from the Bernoulli distribution:

$$Probability ( {P}_{dj}^{r} = 0 ) = {ASR}^{r} ( A , {R}^{r} ) \qquad Eq . 8$$

$$Probability ( {P}_{dj}^{r} = 1 ) = ( 1 - {ASR}^{r} ( A , {R}^{r} ) ) \qquad Eq . 9$$

l_{dj}^{r} is a sample drawn from the loss distribution [symbol] (l|R^{r}, GA). The coefficients γᵣ satisfy the condition

$${\sum }_{r = 1}^{rmax} {γ}_{r} = 1 \qquad Eq . 10$$

in order to have the maximum loss to be equal to L_{dj}. The choice of the coefficients is open to experimentation, with one option for the coefficients to be members of a geometric series

$${γ}_{r} = {a}_{0} \cdot {t}^{r} \qquad Eq . 11$$

$${a}_{0} = \frac{1 - t}{1 - {t}^{rmax}} \qquad Eq . 12$$

where t is a free parameter. Other options can be used as long as the condition Equation 10 is met.

Direct output of running Monte-Carlo simulations for each tuple (A, GA, R) is the probability distribution [symbol] (TL|A, GA, R) of the total losses TL. This probability distribution is used to calculate point estimates of the total losses, such as the mean and median total loss. It is also used to calculate the exceedance curve which give the probability of total losses not to exceed a various value over a specified period of time:

$$Pr ( TL > L ) = {{\int }_{L}}^{∞} ℱ ( l \vert A , GA , R ) dl \qquad Eq . 13$$

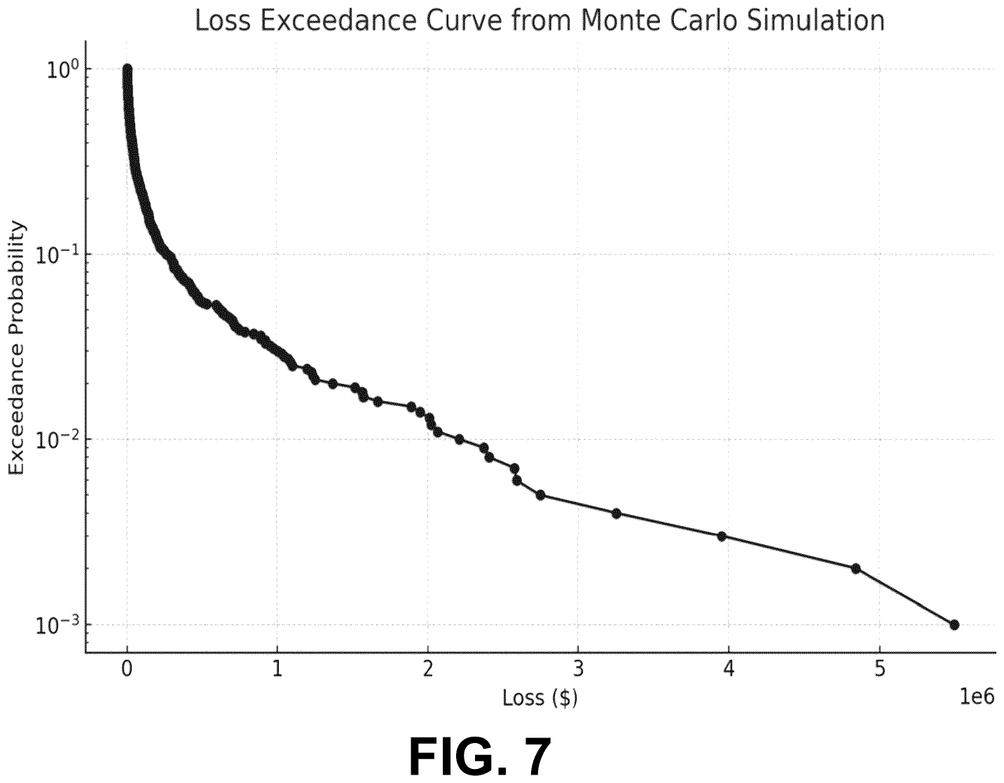

As shown in FIG. 7, potential loss amounts are illustrated on the x-axis (horizontal) and the probability of exceeding those loss amounts are illustrated on the y-axis (vertical).

The response selection manager 130 can select a response R (A,GA), i.e., an optimal response, based on several different set of criteria. Some options include: (1) The smallest probability of a catastrophic loss Pr(TL>$10 M); (2) The smallest mean loss with the probability of a catastrophic loss smaller than a predefined threshold.

In an example implementation, Response 1 has a mean loss of $10K and a 0.01 probability of loss >$10 M. Response 2 has a mean loss of $20K and the 0.001 probability of loss >$10 M. Since for both responses the probability of $10 M loss is under 0.01, the best response is selected based on the smaller mean loss, which is response 1. In another example Response 1 has the mean loss of $10K and the 0.05 probability of loss >$10 M. Response 2 has the mean loss of $50K and the 0.001 probability of loss >$10 M. Since for response 1 the probability of loss >$10 M is greater than 0.01, the best response is response 2.

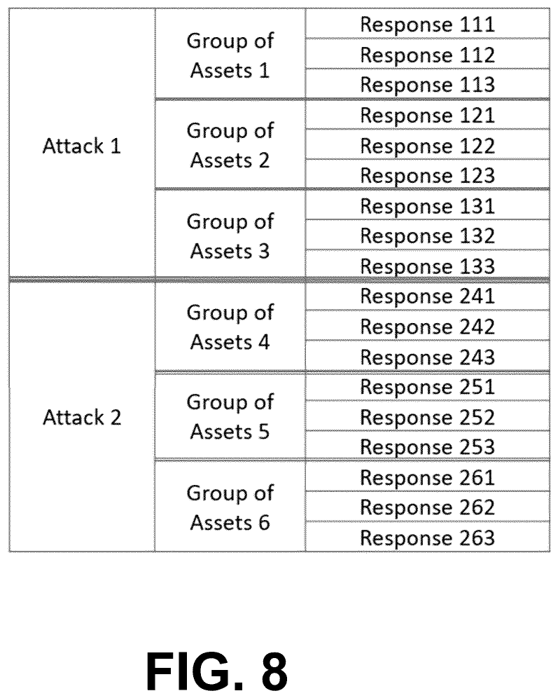

The output of this process is a data structure representing one or more responses for one or more assets (or groups of assets) based on the type of cyber-attack (see FIG. 8). It is also possible to provide a list of responses ranked by the total losses, which the first one having the minimal losses. In this case, if for some beforehand unknown reason, the best response cannot be executed, the second-best response is selected, etc.

In an example implementation, a phishing attack has been detected, i.e., a user clicked a link in a phishing email and malicious software was downloaded. The organization has an internal server hosting a customer database with sensitive information, including customer names, email addresses, and purchase history. The organization also has a local file server where employees store and share sensitive documents. The effected employee has access to both the internal server and the local file server.

Potential responses that can be selected by the response selection manager 130 can include:
1. immediate password reset for the affected user
2. temporary access restrictions of the affected user to the database servers
3. temporary access restrictions of the affected user to the file server
4. isolating the affected user device
5. temporary access restrictions of all employees to the database server
6. temporary access restrictions of all employees to the local server

In some cases, the response selection manager 130 can select multiple options. In this example, the response selection manager 130 may select options 4 and 5 based on the Monte-Carlo simulations because these options correspond to the responses with the smallest potential total losses due the attack and the business disruptions.

For novel cyber-attacks, such as zero-day attacks not captured in existing response strategies, the response selection manager 130 can employ artificial intelligence (AI) algorithms to:
Extract key attack features and characteristics
Match patterns against known attack profiles
Identify closest matching attacks and associated optimal responses
Adapt responses based on specific asset group characteristics

In various implementations, suitable artificial intelligence algorithms can include, but are not limited to: random forest with dynamic weighting, Deep Q-Networks, Siamese neural networks, and one-shot learning with prototypical networks.

Similarly, if the playbook data structure does not have a Response R to an Attack A for a specific Group of Assets GA, an artificial intelligence algorithm can be used to find the closest match between available GAs and the GA in question using the attributes listed above. The response selection manager 130 processes input data including attack

characteristics, asset information, and historical response outcomes to generate probability distributions. These distributions account for various factors that can influence both attack-related losses and business disruption costs.

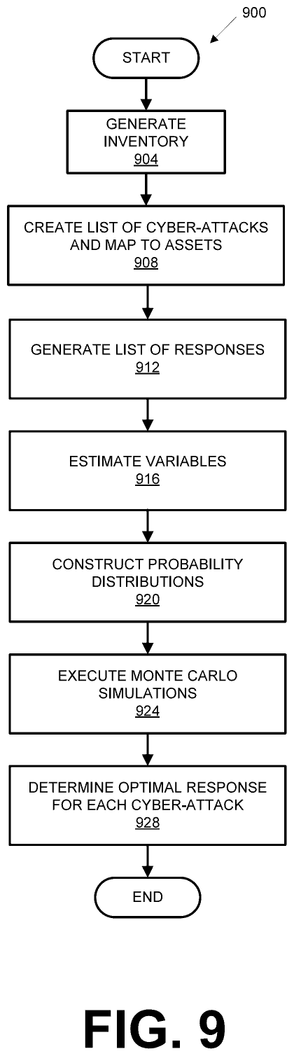

FIG. 9 is a flow chart of an example process 900 for determining a response for one or more cyber-attacks. In one or more implementations, one or more process blocks of FIG. 9 may be performed by the response optimization manager 130.

At block 904, the response optimization manager 130 generates an inventory of organizational assets. This inventory comprehensively catalogs all computing devices, network resources, and user accounts within the organization's infrastructure. At block 908, the response optimization manager 130 creates a list of cyber-attacks and maps these attacks to the identified organization assets, establishing relationships between potential threats and vulnerable assets.

At block 912, the response optimization manager 130 generates a list of responses to the cyber-attacks and maps these responses to the corresponding attacks. The mapping process considers both containment and eradication responses appropriate for each type of attack and asset combination.

At block 916, the response optimization manager 130 estimates variables for the probabilities of the Monte Carlo simulations. These variables incorporate factors such as attack frequency, potential loss amounts, and business disruption costs. At block 920, the response optimization manager 130 constructs the probability distributions for the Monte Carlo simulations using the estimated variables.

At block 924, the response optimization manager 130 executes the Monte Carlo simulations to evaluate different response scenarios. At block 928, the response optimization manager 130 determines an optimal response for each cyber-attack based on the simulation results, considering both attack mitigation effectiveness and business impact. The process 1000 operates iteratively, with the response optimization manager 130 continuously updating the simulations and response selections as new data becomes available.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A system comprising a computer including a processor and a memory, the memory including instructions such that the processor is programmed to:
determine a loss caused by at least one cyber-attack;
determine a loss caused by business disruptions resulting from responses to the at least one cyber-attack; and
select a response to the at least one cyber-attack to minimize the losses.

2. The system of claim 1, wherein the processor is further programmed to utilize Monte Carlo simulations to quantify potential losses from both the cyber-attack and business disruptions.

3. The system of claim 1, wherein the processor is further programmed to generate probability distributions representing frequency and severity of potential cyber-attacks.

4. The system of claim 1, wherein the processor is further programmed to generate probability distributions representing business disruption costs for different response measures.

5. The system of claim 1, wherein the processor is further programmed to calculate attack success reduction factors for different response measures.

6. The system of claim 1, wherein the processor is further programmed to create a data structure that maps responses to different types of cyber-attacks based on minimizing total combined losses.

7. The system of claim 1, wherein the processor is further programmed to select at least one of a random forest with dynamic weighting, a Deep Q-Network, a Siamese neural network, or a one-shot learning with prototypical network to match zero-day attacks with known attack profiles to determine appropriate responses.

8. A method comprising:
determining a loss caused by at least one cyber-attack;
determining a loss caused by business disruptions resulting from responses to the at least one cyber-attack; and
selecting a response to the at least one cyber-attack to minimize the losses.

9. The method of claim 8, further comprising: utilizing Monte Carlo simulations to quantify potential losses from both the cyber-attack and business disruptions.

10. The method of claim 8, further comprising: generating probability distributions representing frequency and severity of potential cyber-attacks.

11. The method of claim 8, further comprising: generating probability distributions representing business disruption costs for different response measures.

12. The method of claim 8, further comprising: calculating attack success reduction factors for different response measures.

13. The method of claim 8, further comprising: creating a data structure that maps optimal responses to different types of cyber-attacks based on minimizing total combined losses.

14. The method of claim 8, further comprising: selecting at least one of a random forest with dynamic weighting, a Deep Q-Network, a Siamese neural network, or a one-shot learning with prototypical network to match zero-day attacks with known attack profiles to determine appropriate responses to match zero-day attacks with known attack profiles to determine appropriate responses.

15. A system comprising a computer including a processor and a memory, the memory including instructions such that the processor is programmed to:
determine a loss caused by at least one cyber-attack;
determine a loss caused by business disruptions resulting from responses to the at least one cyber-attack;
create a data structure that maps responses to different types of cyber-attacks based on minimizing total combined losses; and
select a response from the data structure to the at least one cyber-attack to minimize the losses.

16. The system of claim 15, wherein the processor is further programmed to utilize Monte Carlo simulations to quantify potential losses from both the cyber-attack and business disruptions.

17. The system of claim 15, wherein the processor is further programmed to generate probability distributions representing frequency and severity of potential cyber-attacks.

18. The system of claim 15, wherein the processor is further programmed to generate probability distributions representing business disruption costs for different responses. measures.

19. The system of claim 15, wherein the processor is further programmed to calculate attack success reduction factors for different response measures.

20. The system of claim 15, wherein the processor is further programmed to select at least one of a random forest with dynamic weighting, a Deep Q-Network, a Siamese neural network, or a one-shot learning with prototypical network to match zero-day attacks with known attack profiles to determine appropriate responses.
